(19) United States
(12) Patent Application Publication
(10) Pub. No.: US 2010/0028498 A1
(43) Pub. Date: Feb. 4, 2010

(54) METHOD FOR MANUFACTURING MELT BODIES FOR FOOD ARTICLES AND MELT BODIES FOR FOOD ARTICLES

(75) Inventors: Anthony Benjamin Van Der Drift, Queensland (AU); Ian John Young, South Australia (AU)

Correspondence Address: GROSSMAN, TUCKER, PERREAULT & PFLEGER, PLLC, 55 SOUTH COMMERICAL STREET, MANCHESTER, NH, 03101, US

(73) Assignee: PUCK HOLDINGS PTY LTD, Brisbane (AU)

(21) Appl. No.: 12/518,920

(22) PCT Filed: Dec. 13, 2007
(86) PCT No.: PCT/AU07/01921

§ 371 Date: Jun. 12, 2009

(30) Foreign Application Priority Data
Dec. 13, 2006 (AU) 2006906943

(51) Int. Cl. A23C 19/09; A23P 1/10; B65B 25/06; A23L 1/317; A23L 1/01; A23P 1/12; A21D 13/00

(52) U.S. Cl. 426/96; 426/515; 426/393; 426/272; 426/275

(57) ABSTRACT

A method for manufacturing melt bodies for food articles such as bread rolls is disclosed. The method includes mixing one cheese component that is a flowable cheese with another food component such as a particulate bacon to form a homogeneous mixture. The mixture may also include another cheese component including shredded cheese which helps to give form and structure to the mixture. The mixture is then used to form melt bodies of reproducible size and shape in the form of disks that can be applied to a bread roll to be cooked. Each melt body could be in the form of a disk that can conveniently be applied to the bread roll to form a cheese and bacon roll. The melt body is mounted on an upper surface of a partially baked roll and then cooked together with the roll in a baking oven. The melt body melts but stays bound together on the roll. This helps to reduce wastage and also helps to facilitate portion control. It also enhances the aesthetics by providing a neat and consistent appearance.

### FIELD OF THE INVENTION

This invention relates to the preparation of foodstuffs.

This invention relates particularly but not exclusively to a method for manufacturing ready-made melt bodies to facilitate portion control of melts for cooked food articles in the preparation of the cooked food articles. The invention also relates particularly to ready-made melt bodies to facilitate portion control of melts for bread products, such a bread rolls, in the preparation of the bread products incorporating the melts. The invention extends to a method of making a fully cooked food article having a melt. Further, the invention extends to cooked food articles formed in accordance with any one of the methods of the invention. Yet further, the invention relates to a mix for making a cheese body and a method for making a cheese body for a bread product. This invention also extends to a bread product including the cheese body and a method of making a bread product with the cheese body.

This invention relates particularly but not exclusively to a bread product that is a cheese and bacon roll and a method of making this product. It will therefore be convenient to hereinafter describe the invention with reference to this example application. However at the same time it is to be clearly understood that the invention is capable of broader application. For example it could be applied to food articles other than bread products, for example pizzas and toppings for pizzas, and meat products such as cheddar melt steaks.

### BACKGROUND TO THE INVENTION

A cheese and bacon roll is a well known product to bakers in many countries of the world, including Australia, and comprises a bread roll, typically a round roll, having an upper surface on which cheese and bacon is mounted.

The cheese is placed on the roll by sprinkling particulate cheese onto an upper portion of the roll during the baking process. Similarly chopped pieces of bacon are sprinkled on top of the roll during the baking process. During manufacture of the cheese and bacon roll, a baker will randomly pick up a handful of particulate cheese and chopped bacon and manually sprinkle the cheese and bacon particles on the roll. Generally some of the bacon and cheese particles tumble or roll or fall off the side of the roll and onto an adjacent support surface where the cheese and bacon is lost to waste. Thereafter the roll is placed in an oven and baked to form a finished cheese and bacon roll ready to be served to a customer. During the baking process the cheese melts and mixes intimately with the bacon on the roll.

However the manufacture of cheese and bacon rolls in this fashion results in a loss of cheese and bacon. Specifically particles of cheese and bacon that are sprinkled onto the roll tumble off the sides of the roll. This is disadvantageous because these ingredients are reasonably expensive and represent a major input cost in the production of this product.

Further the process of making the cheese and bacon roll requires a baker's expertise to mix up the particles of cheese and bacon and properly sprinkle them on the proven roll with an even consistency before it is fully baked in an oven. This skill and labour also represents a significant input cost in the manufacture of cheese and bacon rolls.

A cheese and bacon bread roll is a low margin product and thus it would be advantageous if the loss of cheese and bacon in the baking process could be kept to a minimum. It would also be advantageous if the labour costs, in particular the cost of skilled labour such as that of a baker, could be kept as low as possible. In view of the large numbers of cheese and bacon bread rolls that are produced in bakeries around Australia a small cost saving per roll would rapidly translate into a large sum of money.

### SUMMARY OF THE INVENTION

According to one aspect of this invention there is provided a method for manufacturing melt bodies for food articles, which method includes:
mixing a cheese component with at least one other food component to form a mixture; and
forming melt bodies from the mixture, so that the melt bodies are ready for application to the food article.

The mixture may be substantially homogeneous. Further each melt body can be applied to the food article and then be subjected to the application of heat to form a prepared food article.

At least one of the cheese component and the other component of the mixture may be of the type that fuses when subjected to the application of heat so as to resist separation of the components during cooking. Specifically the cheese component may fuse when subjected to the application of heat.

The melt bodies may be formed with a reproducible size and shape. This helps to facilitate portion control when making food bodies with melt bodies applied thereto. It also enhances the aesthetics of the product by providing a neat and consistent appearance.

The melt bodies may be shaped and sized to serve as ready made topping melt bodies for mounting on an operatively upper surface of the food article. Instead the melt bodies may be shaped and sized to serve as filling melt bodies for being received within an interior of the food article.

The method may include forming an elongated mixture body from the mixture having a transverse section, and slicing the elongated mixture body into slices having a thickness to form sliced melt bodies. The transverse section of the elongated mixture body and the thickness of the sliced melt bodies may be selected so that the melt bodies are shaped and sized to suit the food articles to which they are to be applied.

The method may also include providing the elongated mixture body as a hard body prior to slicing the elongated mixture body, e.g. by freezing the elongated mixture prior to slicing the elongated mixture body. The method may further include slicing the elongated mixture body to form slices for application to the food articles.

The forming of the melt bodies from the mixture may include separating discrete portions of the mixture from the remainder of the mixture for use in forming individual melt bodies. The discrete portions that are separated from the remainder of the mixture may be capable of being formed into a desired shape.

Forming the melt bodies may include dispensing a metered portion of mixture through an orifice onto a support surface. The method may also include pressing the metered portion of mixture on the support surface into the form of a melt body having a flattened shape.

The method may include causing the melt bodies to harden after they have been shaped, e.g. by freezing the melt bodies. The method may further include packaging the melt bodies and storing the melt bodies in a frozen state until they are in use applied to food articles.

The at least one other component of the mixture may be selected from the group comprising a meat component, a dairy component, a vegetable component, and a fruit component, in addition to the cheese component.

In one embodiment in particular, namely a cheese and bacon roll, the at least one other component is a particulate bacon component.

The mixture may include a binder that helps to bind the components of the mixture together.

The cheese component of the mixture may include a flowable cheese component, and the flowable cheese may act as the binder that helps to bind the components of the mixture together. The mixture may include a further cheese component in the form of discrete particles of cheese. In one embodiment in particular the flowable cheese may be in the form of a liquid cheese and the discrete particles of cheese may be in the form of shredded cheese.

The method may include adding a flavoring agent to the mixture, which flavoring agent is selected from the group comprising natural and artificial flavoring agents.

According to another aspect of this invention there is provided a melt body for a food article, which melt body includes:
a mixture of food components that includes at least one cheese component mixed with at least one other food component, the mixture being formed into a melt body for application to a food article.

At least one of the cheese component and the other component of the mixture may be of the type that fuses during cooking to resist separation of the components during cooking. Conveniently the cheese component may be the component of the mixture that fuses when subjected to heat.

The forming may comprise forming the mixture into melt bodies of reproducible size and shape that are ready made topping melts, i.e. they all look the same and have a neat aesthetic appearance. Instead the forming may comprise forming the mixture into melt bodies of reproducible size and shape that are ready made filling melts.

Each melt body may be hardened prior to its application to a food article. The melt body may be hardened by being frozen prior to its application to a food article.

The mixture may include a binding agent for binding the components of the mixture together. The cheese component in the mixture may be a flowable cheese component, and the flowable cheese component may serve as the binding agent. The mixture may include a further cheese component which is in the form of a particulate cheese.

The at least one other component of the mixture may include one or more components selected from the group comprising a meat component, a dairy component, a vegetable component, and a fruit component. In one embodiment the meat component includes a particulate bacon component. Further the mixture may include a flavoring agent selected from the group comprising natural and artificial flavoring agents.

The melt body may be disk shaped and the size of the disk may be selected to suit the food article to which it is to be applied in use, e.g. bread roll, slice of bread, or pizza base.

According to another aspect of this invention there is provided a method of manufacturing melt bodies for use in the preparation of bread products incorporating melts, which method includes:
forming a cheese component and at least one other food component into melt bodies that are shaped for application to the bread product.

The method may include mixing said cheese component and at least one other food component to form a mixture, and forming the melt bodies from the mixture.

At least one of the cheese component and the other component of the mixture may be of the type that fuses during cooking so as to resist separation of the components during cooking, e.g. the cheese component.

One cheese component in the mixture may be in the form of a flowable cheese. The mixture may include another cheese component in the form of a particulate cheese component. The mixture may include at least one other component that is a particulate bacon component.

The step of forming includes forming the components into reproducible melt bodies suitable for use as melt toppings on bread products that are bread rolls, circular bread rolls or buns such as cheese and bacon rolls.

The method may include forming an elongated mixture body having a transverse section from the mixture, and slicing the elongated mixture body into slices having a thickness to form sliced melt bodies, the transverse section of the elongated mixture body and the thickness of the slices being selected so that the melt bodies are ready for direct application onto bread products.

The method may include forming a frozen elongated substantially cylindrical mixture body from the mixture, and slicing the frozen elongated mixture body into slices for preparation of the melts of the bread products.

The forming of the ready made melt bodies from the mixture may include separating discrete portions of the mixture from the remainder of the mixture. The forming may further includes shaping the discrete portions of mixture into melt bodies of reproducible shape and size ready for subsequent use in the preparation of the melts on the bread products.

The method may includes freezing the discrete portions after they have been shaped into melt bodies.

The method may include any one or more of the optional method steps defined above according to the first aspect of the invention.

According to another aspect of this invention there is provided a melt body for forming a melt on a bread product, which ready made melt body includes:
at least one cheese component and at least one other food component that have been formed into a melt body for application to a bread product.

At least one of the cheese component and the at least one other food component may be of the type that fuses during cooking to resist separation of the components during cooking. Conveniently the cheese component may be the component that fuses during cooking.

The cheese component may be in the form of a flowable cheese and the body may include another cheese component that is in the form of a particulate cheese.

The at least one other food component may include a particulate bacon component.

Each melt body may have a disk shape and the melt body may be sized for mounting over a circular bread roll, e.g. a roll or bun having a similar size to a hamburger roll. Instead each melt body may be rectangular shaped for being placed on a correspondingly shaped bread article. It will be appreciated that some bread products including bread rolls are rectangular shaped.

According to another aspect of this invention there is provided a method of making a cooked food article, which method includes:
mounting a melt body including at least one cheese component and at least one other food component, on the article that is to be cooked; and
placing the article with melt body mounted thereon in a cooking apparatus to cook the article and cause the melt body mounted thereon to melt.

The cooking apparatus may be a baking oven. Further the article to be cooked may be a bread roll.

The melt body may include any one or more of the features of the melt body defined above according to the second aspect of the invention.

The cooking apparatus may be a baking oven. Further the article to be cooked may be a bread roll and the cooked article that is produced may be a cheese and bacon roll.

Further the method may include treating the bread roll in a proving oven prior to the cheese body being placed on it and prior to it being cooked in the cooking apparatus.

According to yet another aspect of this invention there is provided a cheese mix for use in making a melt body for application to a food article, the cheese mix comprising;
a first cheese component that is in a flowable form; and
a second cheese component that is in the form of particulate cheese.

The first cheese component may be a liquid cheese and may help to bind the components of the mixture to each other. The cheese may in particular be a liquid cheese, e.g. with a high viscosity, comparable to that of syrup or honey.

The first cheese component may also be in the form of a paste.

The particulate cheese may comprise a shredded cheese or strands of cheese and may help to give the mixture some body and form. Conveniently the cheese strands may be formed by grating or shredding a block of cheese to yield the plurality of strands.

In this specification the term cheese strands is to be interpreted broadly and to cover all forms of particulate cheese of solid form having discrete elongate elements. This includes all forms of cheese elements formed by grating and shredding.

The grated cheese may comprise strands that overlap and cross each other and this forms a loose structure for the mix. By contrast the flowable cheese fills in the spaces between the shredded cheese particles and tends to bind loosely to the grated cheese. The shredded cheese is not unlike a mat of fibreglass that provides form and structure and the liquid cheese component resemble a liquid resin in that it helps to bind the strands together.

The shredded cheese may have strands having a length of about 5-40 mm, e.g. 10-25 mm, and a nominal diameter of about 3-10 mm. The shredded cheese may be cheddar cheese. Blocks of cheddar cheese have a consistency and body that confers an appropriate mechanical strength on the strands of cheese.

The mix may include one or more additional food components. The additional food components may include one or more of the following: bacon, sausage, salami, mince, fish, prawns, shrimps and ham. Further the additional food components may also include: tomatoes including fresh tomatoes and sundried tomatoes, olives, chives, garlic, pepper and wasabe. These other food components are provided by way of example and are not to be construed as limiting the food components that can be used. In particular, any other food components that are known as ingredients of a pizza topping may also be used.

The additional food component may be in a particulate form, e.g. chopped bacon, sausage or ham. Instead the additional food component may be in a whole or unitary or unchopped form, e.g. a strip of sundried tomato. A said mix may contain a combination of an additional food component in a particulate form and another component in a whole or unitary form which is unchopped.

In one particular form of the invention the mix has one additional food component that is bacon. Thus in this form the mix comprises liquid cheese, grated cheese and chopped bacon and this can be used to provide a cheese mix for making a cheese and bacon roll.

The liquid cheese binds the additional food component such as chopped bacon together with the strands of cheese so that the mix is inclined to hold or bind together as a single body or entity when the mix fuses and melts when the article of food is cooked. This helps to keep the components together when the cheese melts.

The mix may be stored at a maximum of 4 degrees Celsius once it is mixed as is usual for foodstuffs of this sort. This helps to resist bacterial or fungal contamination.

According to another aspect of this invention there is provided a method of making a cheese body for placing on a bread product, the method comprising:
providing a mix of strands of cheese and flowable cheese;
forming discrete cheese bodies with material taken from the mix; and
freezing the discrete cheese bodies to preserve the bodies for storage and distribution.

The mix of strands of cheese and flowable cheese may be in accordance with the preceding aspect of the invention described above. In particular the strands of cheese may be shredded cheese and the flowable cheese may be liquid cheese.

The mix of strands of cheese and flowable cheese may optionally have one or more additional food components.

The cheese mix may include any one or more of the optional features of the cheese mix described above in the preceding aspect of the invention.

The method may also include an initial step of mixing the mix of strands of cheese and flowable cheese before it is formed into the discrete bodies in the subsequent method steps.

In particular the cheese mix may include at least one food component such as bacon, e.g. chopped bacon, distributed through the mix. The liquid cheese may be in a liquid form having a high viscosity such as that encountered with syrup or treacle.

In one form the step of forming discrete cheese bodies with material taken from the mix may comprise repeatedly discharging discrete quantities of material from an outlet, each said discrete quantity of material forming a body of cheese mix. The quantity of material described each time may be metered volumetrically, e.g by means of a piston and cylinder.

The method may further include flattening each body of cheese mix, e.g. by moving two opposed plates towards each other, to form a flattened body with two major surfaces. The body of cheese material may resemble a patty such as a patty for a hamburger.

In said one form the discrete cheese bodies are formed in a manner that is similar to the forming of hamburger patties. The apparatus used to discharge and discrete quantities of material and then flatten them may be similar to or even the same as the apparatus used to form hamburger patties.

In another form, the step of forming discrete cheese bodies comprises injecting mix into an elongate casing, e.g. a sausage casing, and then freezing the casing with the mix within it. The hard frozen sausage is then taken out of the freezer environment and the casing is retracted along part of the sausage exposing the cheese mix beneath it. Slices of cheese mix are then sliced off the sausage to yield a said discrete flattened cheese body with two major surfaces. These slices can then be freeze packed and distributed for use.

In said other form the discrete cheese bodies are formed in a way that resembles forming a sausage and then slicing it into slices of mix.

In both forms above, the body of cheese material that is formed may be a flattened body with two major surfaces opposed to each other, e. g. a sheet or disk or patty of cheese material. In particular the sheet of cheese material may have a circular shape, e.g. in plan view.

In one form the sheet of cheese material may be a slice of cheese mix. The body of cheese mix may have a thickness of 5-10 mm, e.g. about 6-8 mm and a weight of 20-40 g, e.g. 25-35 grams. In this form the sheet of cheese material may be referred to as a medallion.

In another form the sheet of cheese material may have a size approximating that of a pizza base again with a circular shape when viewed in plan view, e.g. 20-50 cm, 25-40 cm and a weight of 100-300 g.

This invention also extends to a cheese body for placing on a bread product made in accordance with the above method.

According to another aspect of this invention there is provided a cheese body having two major surfaces for placing on a bread product, the body comprising a mix of cheese strands and flowable cheese, in accordance with that defined in the preceding aspect of the invention described above.

The cheese mix may include any one or more of the optional features of the cheese mix described above in any preceding aspect of the invention. In particular the cheese mix may optionally include one or more other food components.

The body may have a low profile with two major surfaces, e.g. in the form of a disk or patty or puck and the body may have a circular shape. In one form where the body is to be placed on a bread roll the body has a diameter of about 10-14 cm. In this form the body may be referred to as a medallion. In another form where the body is to be placed on a pizza base the body may have a diameter of about 20 to 50 cm, e.g. 30-40 cm.

According to another aspect of this invention there is provided a partially baked bread product, the product comprising:
a bread product having an upper surface, that has been proven in a proving oven; and
a cheese body or melt body made in accordance with any preceding aspect of the invention mounted on the upper surface of the bread product.

The bread product may comprise a body of dough that has risen partially. The bread product may be a bread roll, e.g. a proven bread roll. Instead the bread product may be a pizza base. Further the bread product may include an article of unleavened bread.

The cheese body or melt body may include any one or more of the features of the cheese body or melt body in any preceding aspect of the invention.

According to another aspect of this invention there is provided a method of making a fully baked product, the method comprising:
placing a cheese body or melt body in accordance with any preceding aspect of the invention on a bread product; and
placing the bread product in a baking oven to bake the bread and cause it to rise fully and to cause the cheese body thereon to melt.

The structure of the cheese body with the shredded cheese and the liquid cheese assists in holding the mix on the roll so that there is little or no cheese or food component that runs off the roll and is lost from the final bread product.

The bread product may have been proven in a proving oven prior to the cheese body being placed on it.

Applicant has found that the time taken to bake a proven roll into a fully baked bread roll is the same amount of time taken to thaw the cheese body and then melt and brown the cheese, and therefore this step complements the baking of the roll in a baking oven. The two distinct processes are done together and take about the same length of time.

The cheese body may be frozen when it is placed on the bread roll. In this case the baking process may also thaw the cheese body in addition to melting the cheese and browning it.

The baking process may comprise placing the piece of bread in an oven at 220 degrees Celsius for 15-30 minutes, e.g. about 18-25 minutes.

The piece of bread may be a bread roll, e.g. a round bread roll.

Naturally this invention also extends to a finished bread product that is made in accordance with the method described in the preceding aspect of the invention.

The finished bread product may be a bread roll with cheese and an additional food component thereon, e.g. a cheese and bacon roll. Instead the finished bread product may be a pizza base with cheese and other pizza ingredients thereon.

According to another aspect of this invention there is provided a medallion for placing on a proven roll prior to baking the roll to make a bacon and cheese roll, the medallion comprising a circular body of cheese mix having two major surfaces, and the cheese mix including liquid cheese, grated cheese and also chopped bacon.

The cheese mix may include any one or more additional food components thereon.

According to another aspect of this invention there is provided a method of making a cheese and bacon roll, comprising:
providing a round bread roll that has been proven in a proving oven but has not yet been fully baked; and
placing a melt body or a cheese body in accordance with any preceding aspect of the invention on the bread roll; and
baking the bread in an oven to cause it to rise fully and melt the cheese in the medallion to yield a finished cheese and bacon roll.

The melt body may include liquid cheese, shredded cheese and particulate bacon.

### DETAILED DESCRIPTION OF THE PREFERRED EMBODIMENTS

A ready-made melt body or a cheese body and a method of manufacturing same and a method of making a bread product with the ready-made melt body and/or cheese body in accordance with this invention may manifest itself in a variety of forms. It will therefore be convenient to hereinafter provide a detailed description of the invention with reference to several example embodiments. The purpose of providing this detailed description is to instruct persons having an interest in the subject matter of the invention how to put the invention into practical effect. It is to be clearly understood however that the specific nature of this detailed description does not supersede the generality of the preceding broad description. In the drawings:

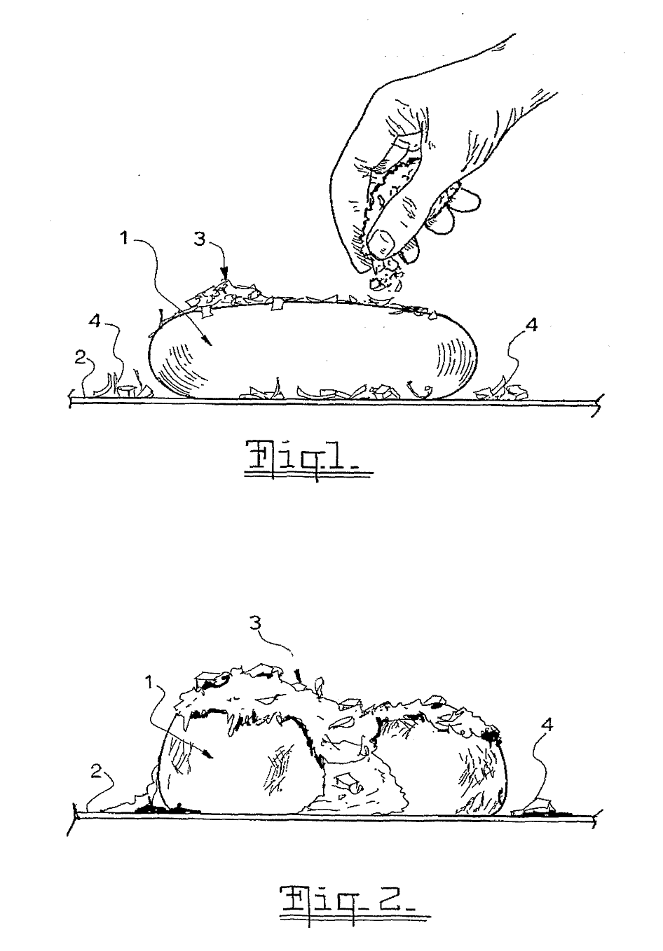

FIG. 1 is a schematic drawing of a cheese and bacon roll being made in accordance with the prior art;

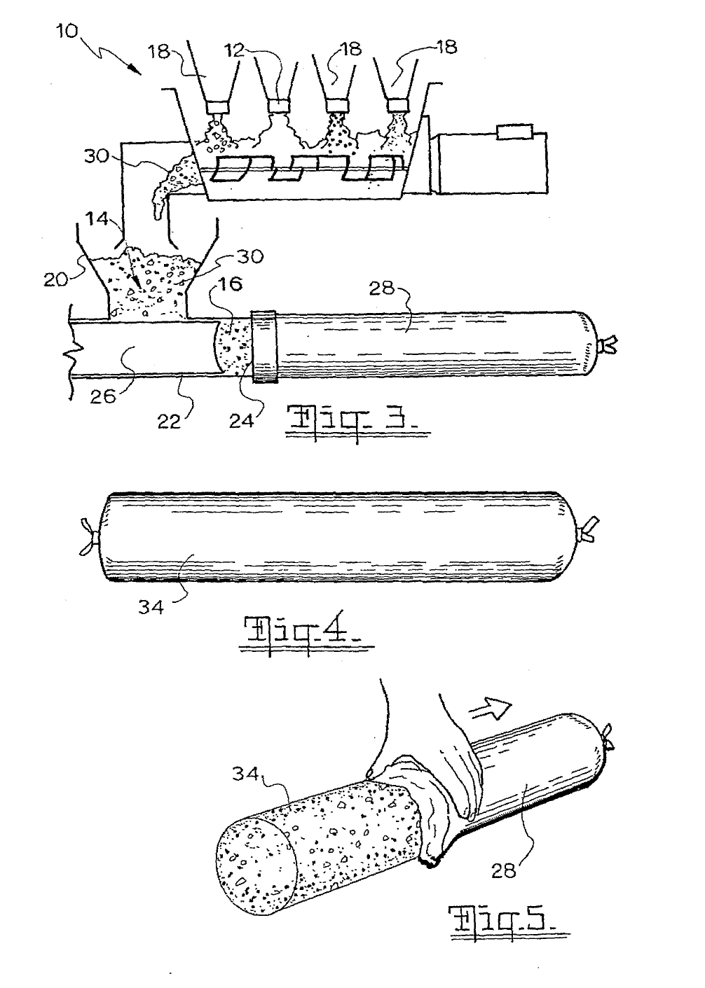

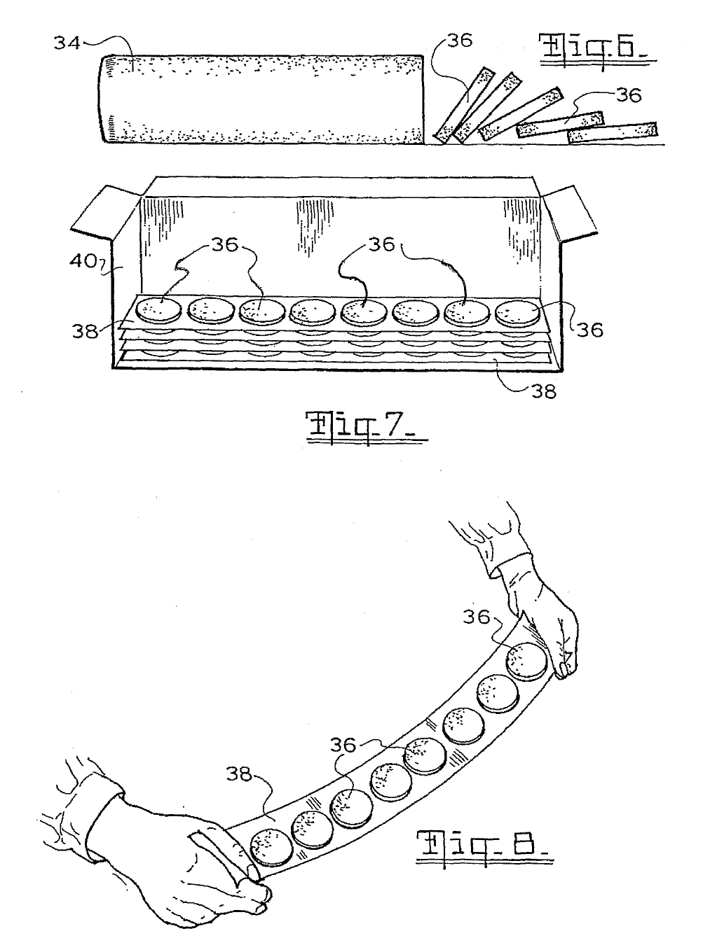

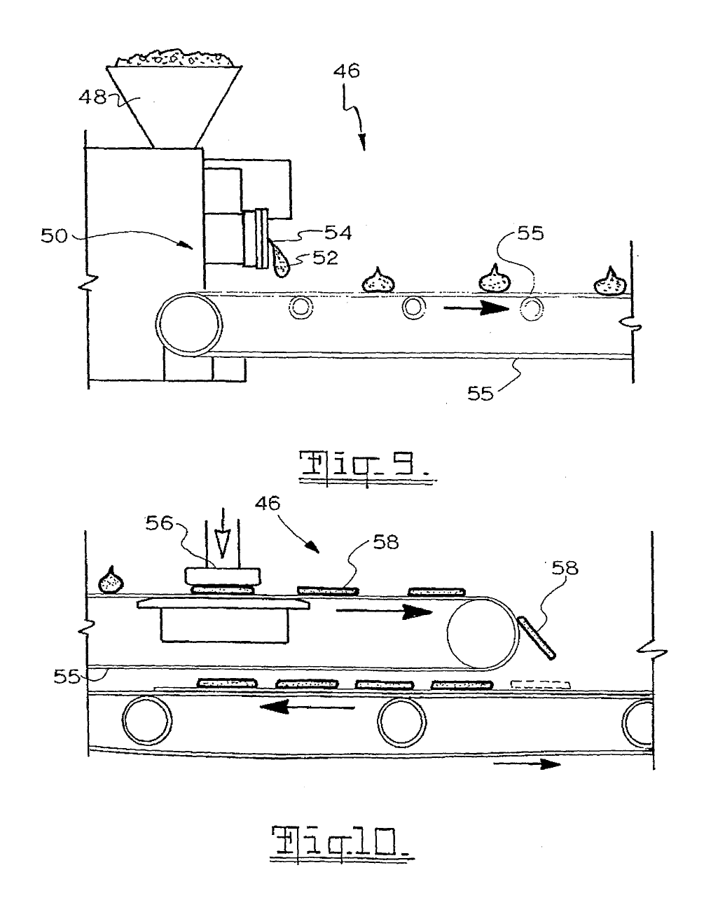

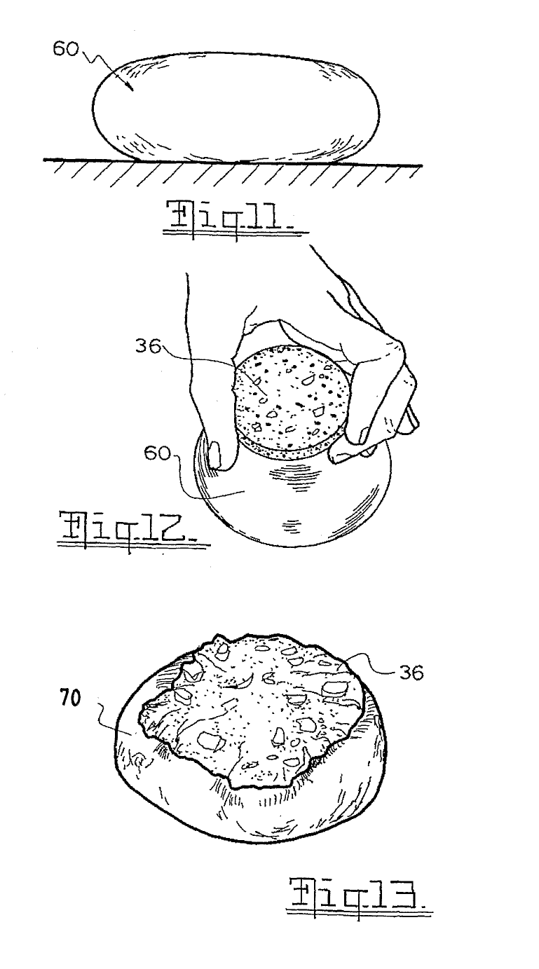

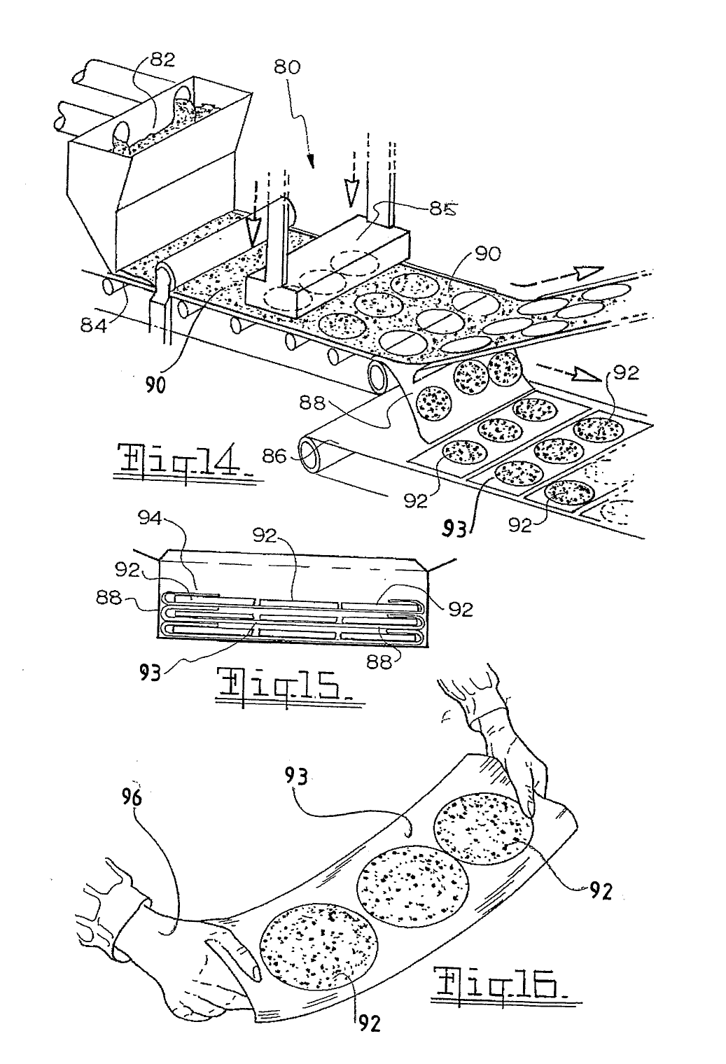

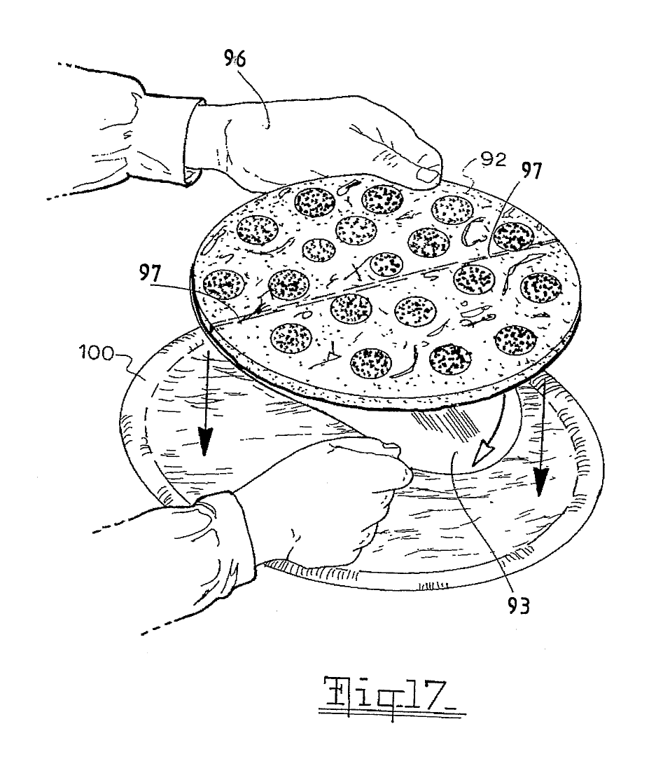

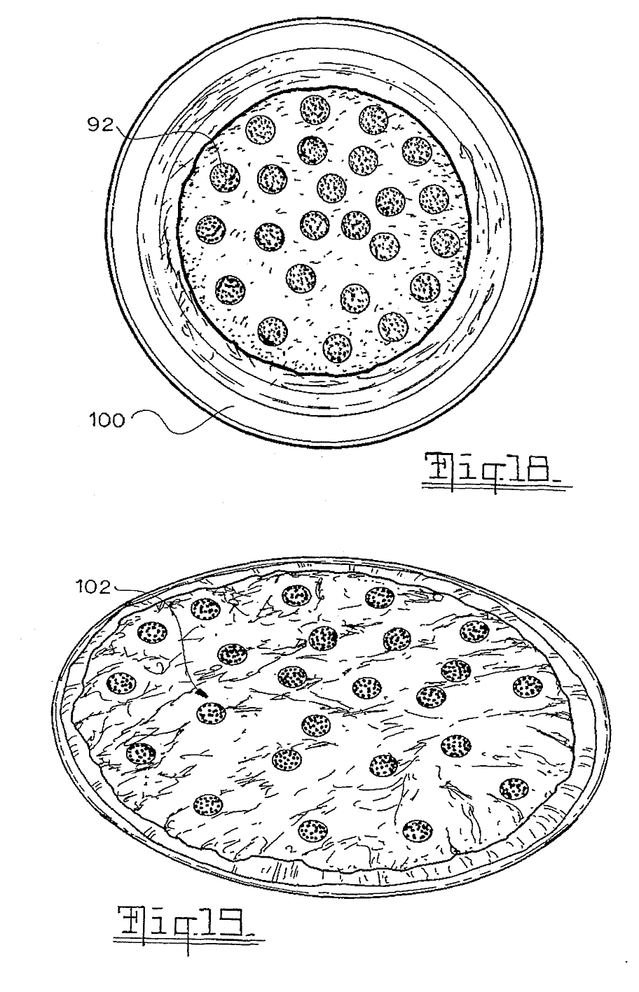

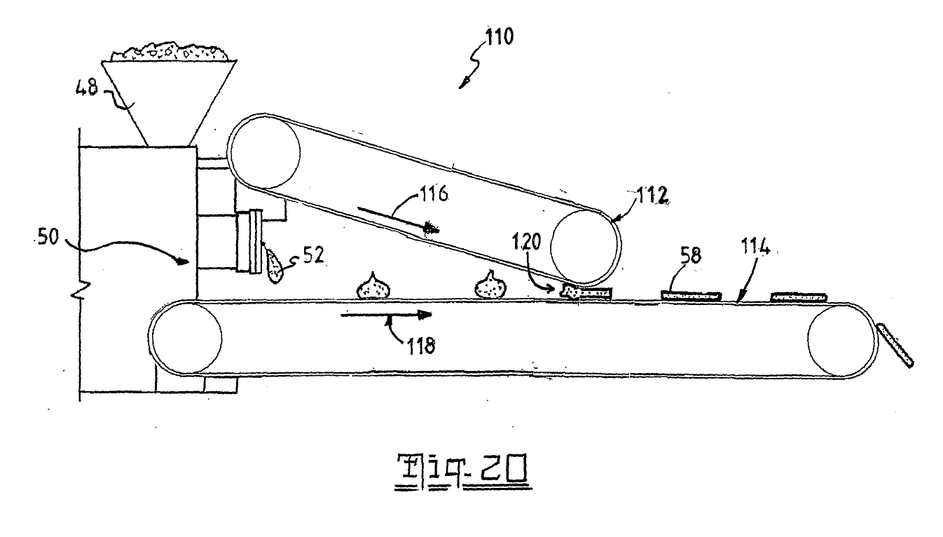

FIG. 2 is a schematic drawing of a cheese and bacon roll that has been fully baked in accordance with the prior art;

FIG. 3 is a schematic drawing of an apparatus having an extrusion orifice through which cheese mix is extruded into a sausage casing;

FIG. 4 is a sausage of cheese mix within a casing that has been tied off at both ends;

FIG. 5 is a schematic drawing of a frozen sausage that has had part of the casing removed to ready it for slicing;

FIG. 6 is a schematic view of the sausage with skin removed that has had a number of slices of cheese sliced off it;

FIG. 7 is a box of cheese bodies that is being freeze packed in a box for distribution;

FIG. 8 is a sheet of cheese bodies that has been removed by a baker from the freeze packed box in preparation for its use;

FIG. 9 is a schematic drawing of a first section of a patty forming apparatus being used for making the cheese bodies in a different way to that shown in FIGS. 3 to 6;

FIG. 10 is a schematic drawing of a further section of the apparatus shown in FIG. 9 showing how the cheese bodies are flattened to make them suitable for use;

FIG. 11 is a schematic drawing of a proven bread roll that has been partially cooked and partially raised in a proving oven;

FIG. 12 is a schematic drawing showing a baker placing a cheese body like that shown in FIG. 8 on an upper surface of the proven bread roll;

FIG. 13 is a schematic drawing showing the bread roll and cheese body of FIG. 12 after it has been fully baked in an oven to produce a finished bacon and cheese bread roll product;

FIG. 14 is a schematic drawing of an apparatus for forming a cheese body suitable for placing on a pizza base;

FIG. 15 is a schematic drawing showing the cheese bodies formed in FIG. 14 mounted on a sheet and being freeze packed in a box for distribution;

FIG. 16 is a schematic drawing showing a pizza maker handling a sheet of cheese bodies shown in FIG. 15 just prior to their use for making pizzas;

FIG. 17 is a schematic drawing showing the pizza maker removing a bottom sheet from a said cheese body and then placing it on an upper surface of a pizza base;

FIG. 18 is a schematic plan view of the cheese body on a pizza base prior to placing the pizza base in a pizza oven;

FIG. 19 is a three dimensional view of the pizza base of FIG. 17 after it has been fully fired and cooked in a pizza oven; and

FIG. 20 shown is a schematic drawing of another patty forming apparatus being used for making the cheese bodies in another way.

In this description the terms melt body and cheese body shall be used interchangeably and the reference top one shall be deemed to include the other.

FIGS. 1 and 2 illustrate a cheese and bacon roll made in accordance with the prior art.

A partially baked bread roll indicated generally by the reference numeral 1 is shown that has been proven in a prover and placed on a support surface 2 that is a baking tray. A baker manually sprinkles cheese and bacon 3, e.g. in a particulate form, over the bread roll 1 as shown in FIG. 1. Some of the particles of cheese and bacon 4 roll off the side of the roll 1 and onto the support surface 2 and are lost from the roll 1.

FIG. 2 shows the cheese and bacon roll 1 once it has been fully baked. The cheese has melted on the roll 1 and some of the cheese has run down the side of the roll 1 and onto the baking tray 2. Generally this cheese is lost from the roll 1 and is ultimately thrown away as is the cheese and bacon 4 that fell off the roll 1 in the initial step of sprinkling the cheese and bacon 3 on the roll 1.

FIG. 3 shows an apparatus for forming a sausage casing filled with cheese mix.

The apparatus is indicated generally by the reference numeral 10. The apparatus 10 comprises broadly a dispenser 12, a mixer 14, and a sausage extruder 16.

In the illustrated embodiment the dispenser 12 comprises a separate container 18 for each of the components of the cheese mix and means for dispensing metered quantities of the components into the mixer 14.

The mixer 14 comprises a mixer container 20 that opens upwardly and has means for agitating or mixing the cheese mix (not shown). In one form the mixer is a mechanical stirrer.

The extruder 16 comprises a cylindrical body 22 defining an extrusion orifice 24 at one end and a ram or piston 26 that is movable in a longitudinal direction to discharge cheese mix through the orifice 24. The cylindrical body 22 includes attachment means, e.g. in the form of a clip or shoulder, around the extrusion orifice for attaching an open end of a sausage casing 28 thereto.

The mix which is generally shown by reference numeral 30 comprises a flowable cheese which is a liquid cheese and strands of the cheese in the form of a shredded cheese. In one example embodiment the shredded cheese may be cheddar cheese. The liquid cheese may be a liquid cheese that is sold by Mexican Express Pty Ltd at 87 Harrison Road, Dudley Park, SA, under the trade mark MEXICAN EXPRESS™.

The mix also includes one or more additional food components which are added to the cheese. In the example of a cheese and bacon roll the additional food component comprises bacon in a particulate form, e.g. chopped bacon.

The additional food components can be vegetable, fruit, dairy, and/or meat components, depending on the type of melt that a user desires for the preparing a cooked article. Further, the mix can include flavoring agents, herbs and/or spices, viscosities, or binding agents to adapt the mix for forming the cheese bodies or ready-made melt bodies to a desired application.

The components of the mix 30 are mixed by means of gentle agitation at a cool temperature of 0-4 degrees Celsius, e.g. 0 degrees Celsius. The mix 30 is extruded through the extrusion orifice 24 into the elongate sausage casing 28. Once the sausage casing 28 is filled with cheese mix 30 then the casing 28 is detached from the extrusion orifice 24 and is tied off to form a cheese mix sausage 34 as shown in FIG. 4. The sausage 34 is then frozen in a freezer to harden it and render it suitable for slicing. Once it is fully frozen the cheese sausage 34 is removed from the freezer and the casing 28 is retracted from one end of the sausage 34 to expose a longitudinal body of solidified cheese mix for slicing as shown in FIG. 5.

The sausage of cheese mix 34 is then sliced in the manner shown in FIG. 6 to yield a number of thin and round slices 36 of cheese mix that could be described as cheese medallions. These slices or 36 are then placed on a support sheet 38 of flexible material and freeze packed in layers in a cardboard box 40 as shown in FIG. 7.

FIGS. 3 to 7 described above have illustrated one way of forming a plurality of ready-made melt bodies in the form of round cheese bodies, in accordance with the invention.

FIGS. 9 and 10 illustrate an alternative method of producing a thin round cheese body.

In FIG. 9 an apparatus for dispensing a body or portion of fixed volume of cheese mix from a container of cheese mix onto a support surface, e.g. a conveyor belt is shown generally by numeral 46.

The apparatus 46 comprises broadly a mixer hopper 48 and a dispenser 50 having a ram (not shown) for dispensing a fixed volume of mix 52 out of an outlet 54. The volume of mix 52 is in the form of a ball or blob of cheese mix. The apparatus also includes a conveyor belt 55 for conveying dispensed bodies of cheese 52 away from the dispenser 50.

The apparatus 46 also includes a press 56 having opposing surfaces for flattening the individual bodies 52 dispensed from the dispenser into patty shaped bodies 58 which is shown in FIG. 10. The body of cheese mix 52 is passed between the opposing surfaces of the press to flatten out the ball of mix 52 to produce the flattened body of cheese 58 with two major surfaces having a shape like a patty and that resembles the slices shown in FIG. 6.

The flattened body of cheese 58 produced in FIG. 10 is then mounted on a support sheet and freeze packed much like the slices shown in FIG. 7. It is important to bear in mind that this method of forming the cheese bodies is equally important to that described with reference to FIGS. 3 to 7 and could be used in preference to that described in FIGS. 3 to 7. The freeze backed boxes of cheese bodies 36, 58 shown in FIG. 7, regardless of the method used to prepare them, are then distributed to bakeries in retail stores and the like where they are used in the baking process.

In a bakery, a baker will produce a batch of proven bread rolls in a prover in the usual way. An example of a proven bread roll is shown in FIG. 11 and indicated generally by reference numeral 60.

The baker will then remove a cheese body 36, 58 from the sheet of freeze packed bodies and place it on an upper surface 62 of the proven bread roll 60 as shown in FIG. 12. It will readily be appreciated that this is a relatively simple process requiring a simple manual hand movement and not requiring any baker's skill.

The proven bread roll 60 is then placed in the baking oven (not shown) and baked into a finished bread roll 70 ready to be eaten. This usually involves baking the roll 60 in an oven at 180-220 degrees Celsius for a period of 20-25 minutes. At the end of this time the bread roll 70 is fully baked and is fully risen as shown in FIG. 13. During the baking process the cheese body 36, 58 on the upper surface of the roll 70 has thawed, melted and then browned while the bread is being baked. This produces a cheese and bacon roll that is ready for human consumption.

The cheese body 36 or 58 which is made of cheese strands as well as liquid cheese tends to bind together when the cheese fuses and melts and little or no cheese and bacon mix is lost off the side of the roll 60 while it is being baked in the oven. Further the cheese body does not break up into a plurality of separate bodies on the surface of the roll when the cheese fuses. It remains bound together as a single entity.

The cheese and bacon roll looks very similar to a cheese and bacon roll made in accordance with prior art techniques to a prospective purchaser. Further the cheese and bacon roll is aesthetically pleasing and looks attractive to a purchaser.

FIG. 14 illustrates an example apparatus for making a cheese body for placing on a pizza base to provide the topping and ingredients for a pizza, the apparatus being indicated generally by numeral 80.

The apparatus 80 comprises broadly a dispensing hopper 82 dispensing cheese mix onto a belt 84 where it forms a sheet of cheese mix 90. The sheet of cheese mix 90 may be dispensed onto a sheet of paper 93, e.g. a sheet of grease proof paper, which is mounted on the conveyor belt. The apparatus 80 also includes a stamp or die 85 for stamping out circular bodies from the sheet of mix 90. The apparatus 80 also includes a product conveyor belt 86.

The mix is mixed up in the hopper 82 and then dispensed onto the belt 84 where it is rolled into the sheet 90. Individual bodies of cheese mix 92 are then stamped out of the sheet 90 by the stamp 85 and deposited onto the product belt 86 together with their associated support sheet 93 from where they can be retrieved and then freeze packed in a box 94 as above. A freeze packed box of cheese bodies 92 is shown in FIG. 15.

The cheese bodies 92 are then distributed to pizza outlets where they can be used to simplify the cooking of pizzas.

In use a pizza maker 96 takes a sheet 93 of cheese bodies 92 out of a freeze packed box 94 as shown in FIG. 16. The pizza maker 96 removes the support sheet 93 then manually places a single cheese body 92 on a pizza base 100 as shown in FIG. 17. This is simple one step process and is much simpler than sprinkling each of the ingredients in turn on the pizza bas 100. Further it is a task that does not need to be carried out by a skilled pizza maker. The cheese body 92 in FIG. 17 has a tear line 97 extending along a diameter thereof. This enables the cheese body 92 to be broken into two halves prior to use and to be swapped with another half of another cheese body 92 to produce a half and half pizza.

The pizza base 100 and cheese body 92 on top of it shown in FIG. 18 is then placed in a pizza oven in the usual way to make a cooked pizza 102 ready to be eaten as shown in FIG. 19.

FIG. 20 is a schematic drawing of another patty forming apparatus 110 being used for making the cheese melt bodies in another way. The apparatus 110 is for dispensing a body of fixed volume of cheese mix from a container of cheese mix onto a support surface provided by the conveyor belt 114. The apparatus 110 comprises broadly a mixer hopper 48 and a dispenser 50 having an outlet opening for dispensing a fixed volume or metered volume of mix 52. The volume of mix 52 is in the form of a ball or blob or body of cheese mix. The apparatus also includes a conveyor belt 112 above the conveyor belt 110, that slants downwards to from a gap 120 between its lower return end and the other conveyor belt 114.

The bodies of cheese mix 52 are conveyed (see arrow 118) on conveyor belt 114 through the gap 120 during which they are pressed or sandwiched by the two conveyer belts 112, 114 to form the patties 58.

In another embodiment of the invention that has not been illustrated, the melt bodies may include a layer of a food component. For example, the melt body may be formed from a layer on or more particulate meat components, for example a particular bacon component, and one or more layers of cheese components. In such case an appropriate binding agent can be used to bind the food components together.

The applicant envisages the application of ready-made melt bodies, in accordance with the invention, in the preparation of many different types of cooked food articles. The ready-made melt bodies may be used as melt fillings or melt toppings for cooked food articles such as meat products. The ready-made melt bodies may form fillings for biscuits or be coated with crumbs or batter to form a cooked product.

An advantage of the cheese mix described above with reference to the drawings is that it tends to stay on a bread roll when placed on the bread roll and later on when being baked. As such cheese material is less likely to be lost during the process of making the cheese and bacon roll. Further the reproducible melt body of even size and shape facilitates control of the portion size applied to the bread article.

Another advantage of the cheese body that is a medallion for placing on a proven roll is that it is placed on top of the roll in a quick and simple manual step that can be performed by unskilled labour. Further it can be done quickly.

Yet another advantage of the cheese body is that it is capable of producing a visually attractive finished product, be it a cheese and bacon roll or a pizza, that is appetising to consumers. Yet further the final product looks very similar to a product made by traditional prior art techniques.

It will of course be realized that the above has been given only by way of illustrative example of the invention and that all such modifications and variations thereto as would be apparent to persons skilled in the art are deemed to fall within the broad scope and ambit of the invention as herein set forth.

What is claimed is:

1-63. (canceled)

64. A method for manufacturing melt bodies for food articles, which method includes:
mixing a cheese component with at least one other food component to form a mixture; and
forming melt bodies from the mixture, so that the melt bodies are ready for application to the food article.

65. A method as claimed in claim 64, in which the mixture is an even mixture throughout that is substantially homogeneous.

66. A method as claimed in claim 64, in which at least one of the cheese component and the other component of the mixture is of the type that fuses when subjected to the application of heat so as to resist separation of the components during cooking.

67. A method as claimed in claim 64, in which the melt bodies are formed with a reproducible size and shape and the melt bodies are shaped and sized to serve as ready made topping melt bodies for mounting on an operatively upper surface of a food article.

68. A method as claimed in claim 64, which includes forming an elongated mixture body from the mixture having a transverse section, and slicing the elongated mixture body into slices having a thickness to form sliced melt bodies, the transverse section of the elongated mixture body and the thickness of the sliced melt bodies being selected to suit the food articles to which they are to be applied.

69. A method as claimed in claim 64, in which forming the melt bodies from the mixture includes separating discrete portions of the mixture from the remainder of the mixture for use in forming individual melt bodies, and wherein the discrete portions that are separated from the remainder of the mixture are capable of being formed into a desired shape.

70. A method as claimed in claim 69, in which forming the melt bodies includes dispensing a metered portion of mixture through an orifice onto a support surface, and pressing the metered portion of mixture on the support surface into the form of a melt body having a flattened shape.

71. A method as claimed in claim 64, which further includes packaging the melt bodies and storing the melt bodies in a frozen state until they are to be applied to food articles.

72. A method as claimed in claim 64, in which the at least one other component is selected from the group comprising a meat component, a dairy component, a vegetable component, and a fruit component.

73. A method as claimed in claim 72, in which the meat component is a particulate bacon component.

74. A method as claimed in claim 64, wherein the cheese component includes a flowable cheese component that helps to bind the components of the mixture together, and the mixture includes a further cheese component in the form of discrete particles of cheese.

75. A melt body for a food article, which melt body includes:
a mixture of food components that includes at least one cheese component mixed with at least one other food component, the mixture being formed into melt bodies of reproducible size and shape that are ready made topping melts for application to an upper surface of a food article.

76. A melt body as claimed in claim 75, in which the cheese component includes one cheese component that is a flowable cheese component and serves as a binding agent and a further cheese component that is a particulate cheese component,

77. A melt body as claimed in claim 75, in which said at least one other component includes one or more components selected from the group comprising a meat component, a dairy component, a vegetable component, and a fruit component.

78. A melt body as claimed in claim 75, in which the melt body is disk shaped and the size of the disk is selected to suit a round bread roll to which the melt body is to be applied in use.

79. A melt body as claimed in claim 75, in which the melt body is stored in packaging in a frozen state and is removed from the packaging in a frozen state prior to its application to a food article.

80. A method of producing a cheese and bacon bread roll, the method including:
providing a proven bread roll base having an upper surface;
providing a meltable cheese body;
placing said meltable cheese body on said proven bread roll base such that it is supported on said upper surface; and
baking the proven bread roll base with the meltable cheese body on said upper surface to bake the bread roll base into a bread roll, and to cause the cheese body to melt and collapse and spread over the upper surface of the roll.

81. A method as claimed in claim 80, wherein the bread roll base has a peripheral edge, and wherein the cheese body has a peripheral edge that is spaced inwardly from that of the bread roll base in plan view prior to baking the bread roll base.

82. A method as claimed in claim 80, wherein the bread roll base is configured to form a round bread roll, and wherein the cheese body is substantially disk shaped and the body has a height (thickness) of 10-15 mm.

83. A method as claimed in claim 80, wherein said baking of the proven bread roll base having the meltable cheese body placed thereon comprises baking the proven bread roll base and cheese body at a temperature of between 180° C. and 210° C. for a time period of between 10 and 20 minutes.
